(19) United States
(12) Patent Application Publication
(10) Pub. No.: US 2014/0362087 A1
(43) Pub. Date: Dec. 11, 2014

(54) System And Method For Quickly Visualizing Oil And Gas Field Data

(71) Applicant: The Information Store, Inc., Houston, TX (US)

(72) Inventors: Barry K. IRANI, Plano, TX (US); Dan SCHENCK, Richmond, TX (US); Tod MAGSTADT, Cypress, TX (US); David RAINS, Richardson, TX (US)

(73) Assignee: THE INFORMATION STORE, INC., Houston, TX (US)

(21) Appl. No.: 14/259,814

(22) Filed: Apr. 23, 2014

Related U.S. Application Data
(63) Continuation-in-part of application No. 14/146,978, filed on Jan. 3, 2014.
(60) Provisional application No. 61/748,571, filed on Jan. 3, 2013.

(51) Int. Cl. G06T 11/20; E21B 41/00

(52) U.S. Cl. CPC G06T 11/206; E21B 41/0092
USPC 345/440

(57) ABSTRACT

A powerful visualization aid is provided for technical petroleum engineers and earth scientists who have a need to analyze and quality control large amounts of oil field data quickly. The data used by the system and method comes from a wide variety of databases normally maintained by petroleum company operations, information technology and management personnel as part of their routine resource extraction business. The system and method present the data in a variety of formats and the system can quickly change the output format to enable a user to rapidly switch between various data presentations.

### CROSS-REFERENCE TO RELATED APPLICATIONS

This application is a continuation-in-part of U.S. patent application Ser. No. 14/146,978, filed on Jan. 3, 2014, which claims priority to U.S. Provisional Application No. 61/748,571, filed on Jan. 3, 2013, each of which is hereby incorporated by reference herein in its entirety.

### BACKGROUND OF THE INVENTION

In the petroleum industry, data related to oil and gas wells is stored in large and complex databases that are difficult to manage. These databases contain a wide variety of data which engineers need to combine in many different ways and view in many different formats. Known tools have not presented this data in a coherent form which allow users to easily process the data and view that data in many different formats. In systems where data can be viewed in different ways or in different formats, the transfer from one viewing mode or from one format to another is very slow and cumbersome.

### SUMMARY OF INVENTION

The system and method of the present invention is a powerful visualization aid for technical petroleum engineers and earth scientists who have a need to analyze and quality control large amounts of oil field data quickly. The data used by the system and method comes from a wide variety of databases normally maintained by petroleum company operations and information technology and management personnel as part of their routine resource extraction business. The system and method present the data in a variety of formats and the system can quickly change the output format to enable a user to rapidly switch between various data presentations. By viewing all of the above data in graphical form and in context, a data analyst or engineer can rapidly determine incorrect, missing, duplicated or skewed data types. Viewing data graphically allows data owners the opportunity to identify missing or incorrect data. In a producing field, the true vertical depth of the formation tops are expected to be at similar depths in neighboring wells. When a large difference or gaps are noted it can indicate a data problem which needs further action. These are researched and it is discovered that the formation tops for these wells were not entered.

### BRIEF DESCRIPTION OF THE DRAWINGS

The patent or application file contains at least one drawing executed in color. Copies of this patent or patent application publication with color drawing(s) will be provided by the United States Patent and Trademark Office upon request and payment of the necessary fee.

FIG. 1 is a functional diagram of the system for quickly visualizing oil and gas field data of the present invention.

FIG. 2 is a block diagram of the components of the stick chart initiator shown in FIG. 1.

FIG. 3 is a map generated by the system of the present invention that is tethered to a stick chart from the stick chart initiator shown in FIG. 2.

FIG. 4 is a stick chart generated by the system shown in FIG. 1.

FIG. 5 is another stick chart generated by the system shown in FIG. 1.

FIG. 6 is a stick chart with an overlay layer showing selected well properties generated by the system shown in FIG. 1.

FIG. 7 is a view of a stick chart tethered to a map generated by the system shown in FIG. 1.

FIG. 8 is a view of a magnifier window utilized in a stick chart generated by the system shown in FIG. 1.

FIG. 9 is a stick chart showing wells with missing tops generated by the system shown in FIG. 1.

FIG. 10 is a stick chart showing missing well data generated by the system shown in FIG. 1.

### DETAILED DESCRIPTION

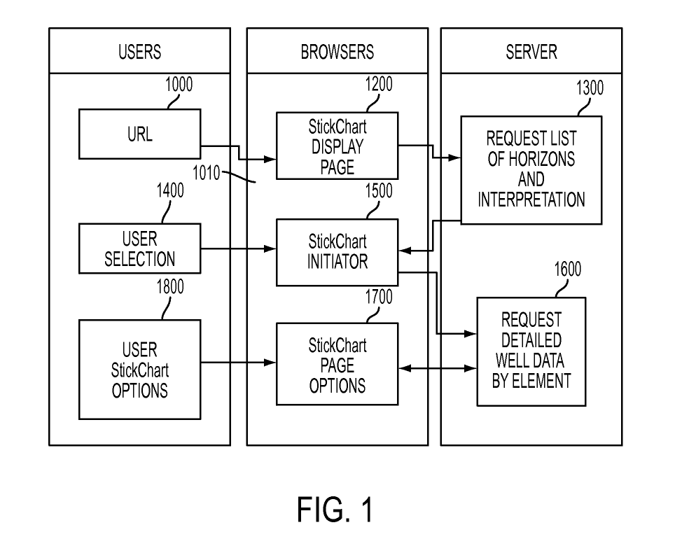

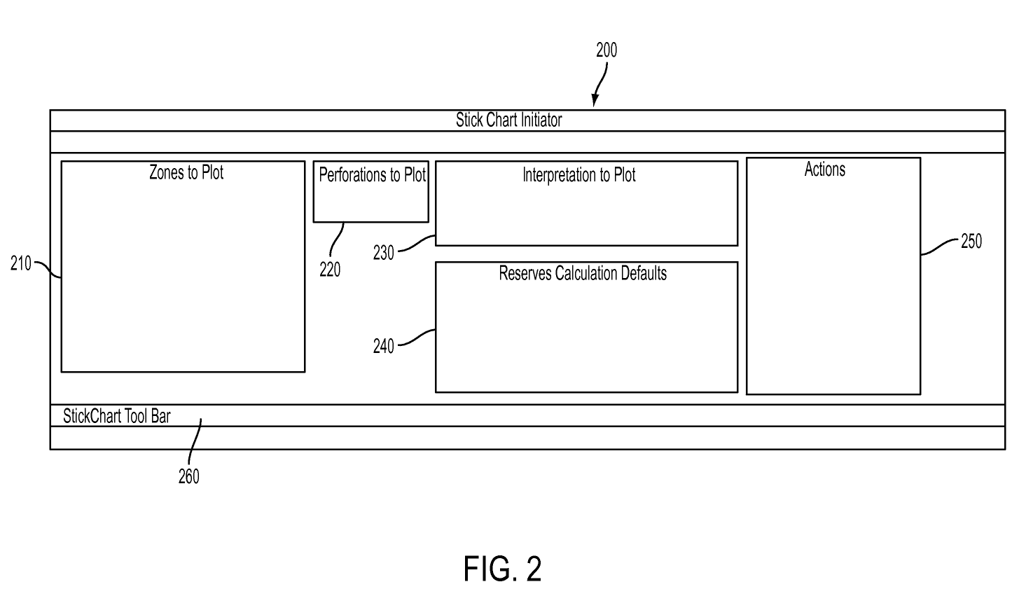

Referring to FIG. 1, the system of the present invention generates a dynamic computer chart which will be referred to herein as a “stick chart” that is used to display detailed oil and gas well data in a variety of ways in order to facilitate interpretation of reservoir characteristics, e.g., hydrocarbon reserves. The stick chart is drawn on an HTML5 canvas using any web browser capable of supporting JavaScript and HTML5 technology. The stick chart consists of two main functional pieces: 1) data selection and preparation; and 2) data presentation and analysis.

The system 10 can access existing data in the different and distinct databases where it is located and move it into a database based on a selected data model. The data may exist externally on servers or within applications in diverse geographic locations using one of many different database management systems, such as Sequel®, Access® or other data bases, Excel® spreadsheets, MS Project® documents or even project MS Word® document files. The applicant's proprietary PDMS (Petrotrek® Data Management System) data model may also be used and this model is based on the PPDM (Professional Petroleum Data Management) data model being used widely in the oil and gas industry and which is becoming standard for the petroleum industry. Preferably which ever application is chosen can hold any and all oil- and gas-related data, whether it is time series production volumes, injection volumes, open hole and cased-hole wireline log measurements, well location, API identification number, well head elevation, pressure test data, significant events in the life of a well or field, core descriptions, sample descriptions, laboratory measurements, well documents and more.

The system 10 also requires the following types of input data delineated by well:
Geologic formation intersections in a well (picks) including name, measured top and bottom depths to the formation within the well, true vertical top and bottom depths
Producing perforations including measured top and bottom depths, true vertical top and bottom depths
Non-producing perforations including measured top and bottom depths, true vertical top and bottom depths
Interpreted possible pay intervals including measured top and bottom depths, true vertical top and bottom depths, average porosity, average water saturation, calculated net thickness
Available well log curves
Hydrocarbon production including cumulative oil, water and gas.
Production summary including current well status, date of first production, initial daily oil volume, last daily oil volume, date of last daily oil, maximum daily oil volume, date of maximum daily oil production, original well status, days on production
Well surface and bottom hole latitude and longitude
Well elevation and reference
Well hole direction
Well name, number and database unique key

Certain default factors are also required that pertain to the set of wells being analyzed:
Formation volume factor (FVF)
Gas/oil ratio (GOR)
Barrels of oil to gas equivalency factor (BOE)
Porosity percent
Water saturation percent
Drainage area per well

The set of wells to be presented is identified by passing a key through the URL 1000 used to initiate the stick chart display 1200. The key can identify an oil field containing wells to be charted or it can be a key identifying an arbitrary set of wells of interest to be charted.

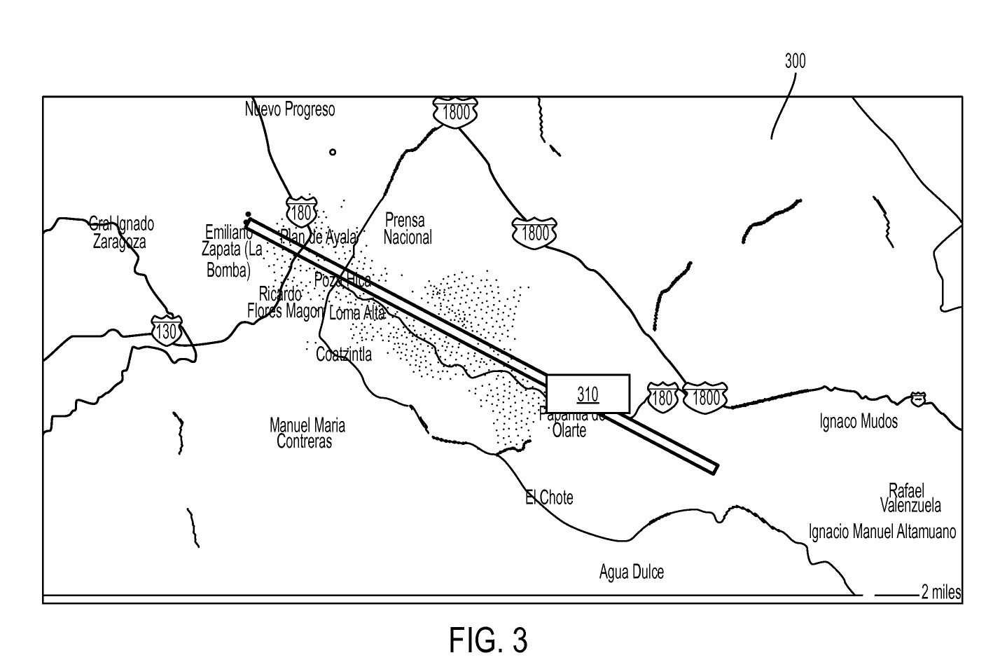

The system 10 includes a user interface (UI) that can be built with commercially available tools such as a dynamic JavaScript framework that hosts 1) a collapsible data selection and preparation panel and 2) a chart panel which in turn hosts an HTML5 canvas containing the stick chart and an optional, tethered map (instantiated in a child browser window) such as a map of the type shown in FIG. 3. A tethered map is a map that is associated and controlled with another user interface element, and when it is a child map the user interface element is subservient to a controlling or parent user interface element. Asynchronous program calls made from the primary application window of the system 10 (an Ajax call) to web services 1300 are used to acquire lists of horizons, perforations and interpreted intervals found in the well set to be studied. An Ajax call is used so that the main window is not waiting and is always responsive to the user. List data is returned to the stick chart initiator 1500 of the system 10 in a format to enable it to build a stick chart. An example of a suitable format would be as JSON objects. JSON objects are a preferred format because they are a structured data object in wide use in the computer industry that allow encapsulation of arbitrarily complex data composed of numerous pieces of information

Data by well is also delivered to the stick chart initiator 1500 of the system 10 by means of Ajax requests to a set of web services which also return the required information as JSON objects.

All standard user interface components of the stick chart are preferably built using a dynamic JavaScript framework. The stick chart itself is preferably built using HTML5 generated from custom JavaScript code.

If the use of the optional tethered map is selected as one of the user stick chart options 1800, the stick chart page option portion 1700 of the browser of the system 10 passes data to and from the optional tethered map by making JavaScript function calls to the map child functions from the stick chart parent or to the stick chart parent functions from the child map.

Element selection choices (horizons, perforations, interpretations) are displayed in the data collection UI as different categories of multi-selection lists 210-260. The user selects zero or more elements from the horizon and perforations lists to include items in the stick chart. The user may only select one interpretation from the interpretations list. Horizons may have both a top and a base which define their extent, or they may be considered to be contiguous, i.e., the base of a horizon is the top of the next lower one, and the base of the last horizon in the stack is the total depth of the well. The UI contains a checkbox component that allows the user to specify if the contiguous option is desired.

All horizon, perforation and interpreted interval selections allow the user to specify a color for that feature on the stick chart. Colors are chosen by clicking a color box associated with each selection item which opens a color pallet from which the user may choose a color.

Default properties are collected from a user by means of input fields in the data collection panel.

After a user has selected a set of elements to include on the chart and has entered the default parameters, those selections may be saved into a named profile for future use. A UI text field component is used to collect a new named setting. Once the text field has been entered, the user may click a button to save the settings. On that click event, the stick chart makes an Ajax call to a web service that accepts a JSON string representation of the selected and default properties and saves the JSON. Previously saved named settings from a user are displayed in a pull-down combobox component. If the user selects a previously saved setting, the data selection and preparation UI retrieves the JSON representation of the settings from that named element and updates the components of the UI with those selections, colors, values, etc.

After a user selects all desired stick chart elements and enters the default properties they can launch the stick chart by clicking a Display Chart button. This click action presents an Ajax request to a web service that retrieves all of the requested data elements for the chart; the web service caches the data for a unique request on the server. The user may specify the number of days the cache will be valid in the UI component. The user may also use a checkbox component to force the cache to be refreshed as part of the Display Chart request.

Upon a successful completion of the Ajax Display Chart request, the stick chart data is transformed from a JSON string into an internal JavaScript object array of well data inside of the stick chart JavaScript object. The initial, unfulfilled stick chart object is created when the web page is first generated, but no drawing of chart elements takes place until chart data is populated from the execution of the Display Chart request.

Once chart data is populated in the stick chart object, a request is made to a chart object method to draw the initial chart. The chart drawing area is confined into a chart panel whose size is determined by the height of the web page minus the height of the data selection and preparation panel and the width of the web page. The chart panel is configured with a menu bar that contains functions for manipulating the chart. That chart drawing area contains a base HTML canvas where all chart elements are drawn.

Each well in the data set represents one rectangle on the chart. The width of each rectangle is based on the pixel width of the canvas divided by the number of wells in the data set. The height of each rectangle is proportional to its total depth relative to the deepest well in the set as a portion of the pixel height of the canvas. All depths on the chart are based on the default unit of measure a user has previously specified as their desired default (meters or feet). If no total depth is present for a well, no base rectangle is drawn, but space is left for the well in the chart.

All wells are initially plotted based on measured depth starting from the surface. Initial drawing begins by creating a rectangle for the first well in the set and proceeds from left to right across the canvas until all wells have been drawn. As a well rectangle is drawn, each element requested by the user that is present in the well is drawn in its correct position in the overall rectangle and filled with the color the user specified. Perforation elements are not drawn completely filled in, but instead are only drawn as outlines with the specified color. The elements are laid down in layers such that some layers will obscure others. The order of drawing is as follows:
Chart depth grid with annotation.
Base well rectangle—filled with default color
Total depth marker denoting the base of the well—filled with a default color
Horizons—filled with user specified color
Interpreted intervals—filled with user specified color
Perforations—outlined with user specified color.

After all well rectangles are drawn, a legend canvas, at a higher z-index level than the base canvas, is drawn on top of the base canvas. The term “z-index” refers to the relative height of a drawing layer. Higher z-index levels obscure the layers with lower z-index levels. Exposing data can be accomplished by manipulating the z-index level of the drawing layer that contains the data. The legend contains, for each user-selected element, the element name and next to the name, a rectangle filled with its color. The legend canvas can be grabbed and moved by the user by depressing the left mouse button. This is accomplished by capturing the mouse click event in JavaScript and moving the canvas based on the mouse movement.

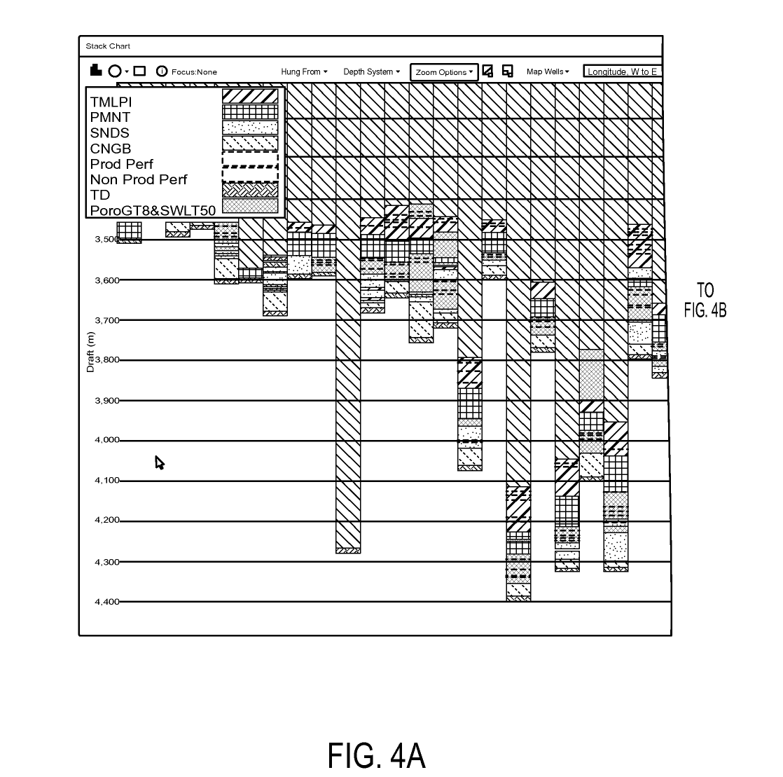

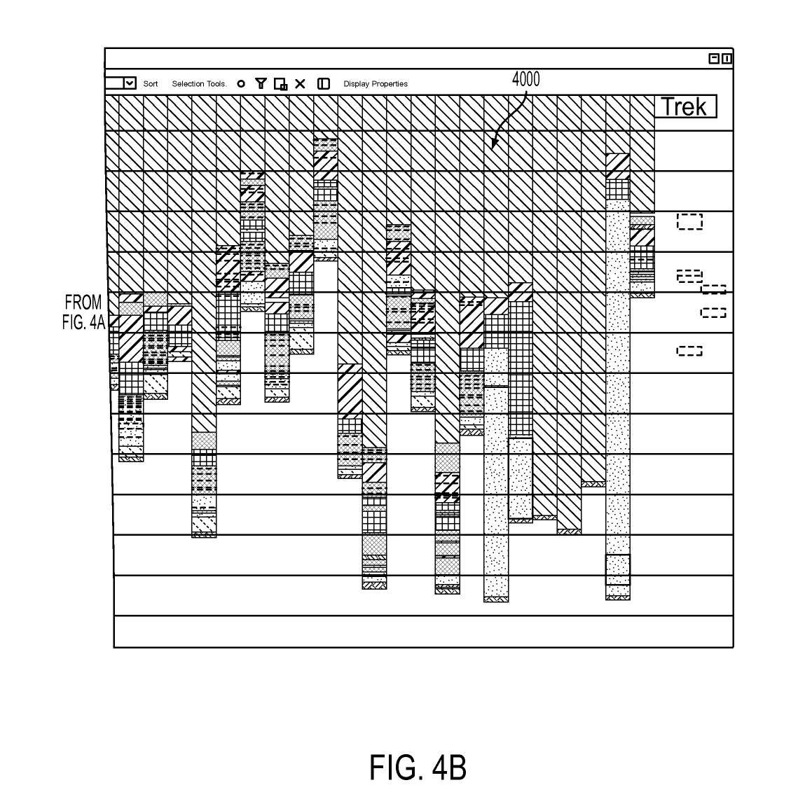

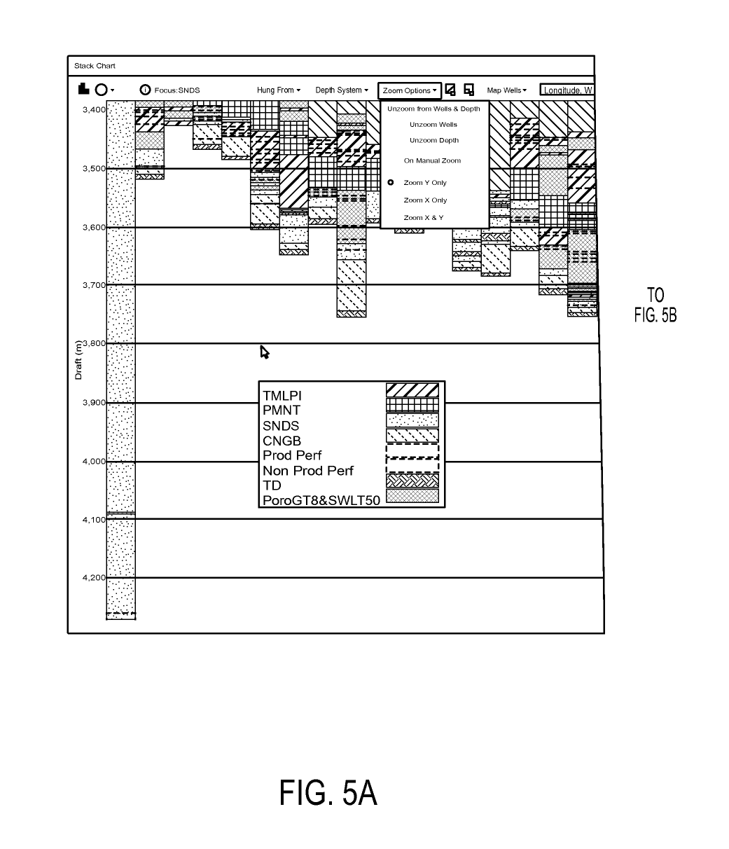

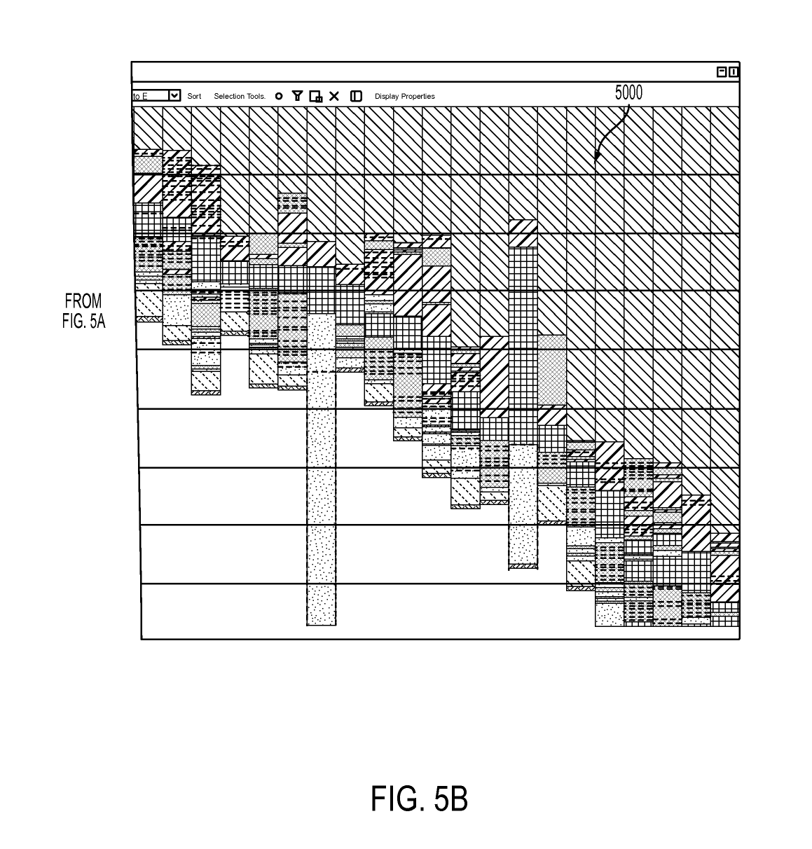

The user can control how the stick chart displays wells in the following ways:
Focus on a specified element.
   Clicking on the color box for an element in the legend causes the stick initiator 1500 or 200 to create a JavaScript event (2000). The chart object listens for that event. On capturing this event, the chart object sorts and redraws the well set on the canvas with the one having the shallowest occurrence of the focus element on the left and the one with deepest occurrence on the right. Wells not containing the focus element are last to be plotted on the right side of the chart.
Zoom
   The Zoom Options menu 210 on the chart menu bar shown in FIGS. 4 and 5 allows the user to zoom the chart display to show only the wells which contain the focus element, or zoom into the depth range for the focus element (minimum chart depth is the shallowest value of the selected element and maximum chart value is the deepest value of the selected element) or both as shown in FIG. 4. Selecting any of the various options results in the publication of a JavaScript event that the chart object listens for that directs it to redraw the chart canvas according to the chosen selection.
Position wells from surface or subsea.
   The Hang From menu on the chart menu bar allows the user to select the starting depth position of each well rectangle. In geologic interpretation, a set of wells will “hang” from a specific reference depth to illustrate different aspects of stratigraphy and structure. The “Hang From” depth must be selected by a user. The default starting position is from the surface of the earth. The user can also select an option in the Hang From menu to reposition wells to start from their subsea value, or depth relative to sea level as shown in FIG. 5. Selecting either the Surface or Subsea options results in the publication of a JavaScript event that the chart object listens for that directs it to position the wells at either the surface or the subsea depth. When this event is captured, the chart redraws the canvas with the appropriate well positioning.
Hang wells from focus element
   When the stick chart is focused on wells and depth, the Hang From menu on the chart menu bar allows the user to “hang” wells on the focus element's top depth or “un-hang” the wells from the focus element (5000). If this option is chosen, an event is propagated that the chart object listens for that directs it to redraw the canvas so that, in the case where “hang” was specified all wells are shifted vertically so that the top of the focus element in each well is located at the 0 depth point, or if “un-hang” was specified all wells are returned to either the surface or subsea position, depending on that setting.
Sort wells
   A combobox on the chart panel menu bar is configured with a list of options for sorting the wells. Options include:
      Longitude, W to E
      Longitude, E to W
      Latitude, N to S
      Latitude S to N
      Well name
      Well number
      Total depth
      Original status
      Current Status
      Elevation
      Cumulative oil volume
      Cumulative gas volume
      Cumulative water volume
      Date of first production
      Date of last production
      Initial oil volume
      Last oil volume
      Maximum oil volume
      Days on production

A Sort button on the menu bar calls a JavaScript function when clicked which sorts the chart object well set based on the selected sort option. Finally, that function fires an event for which the chart object listens that causes the chart object to redraw the canvas using the resorted well set as shown in FIG. 5.

As described above the stick chart has the ability to quickly combine and display graphically all of the data types above in a visual interface as well as the ability to sort by (ref sort table) as well as to change the viewing characteristics (ref view char). Along with the above options the operator can also invoke a number of overlay options from a drop down list of data attributes such as:
BDT Cum Oil
BDT Cum Gas
BDT Cum Water
Local Cum Oil
Local Cum Gas
Local Cum Water
BDT Reserves
Local Reserves
BDT First Prod
BDT Last Prod
BDT Max Prod
BDT Init Oil
BDT Max Daily Oil
BDT Total Days On
BDT First Produced
Original Status
Current Status
Well No.
Elevation
TD
Log Count
Hole Direction
Surface Lat

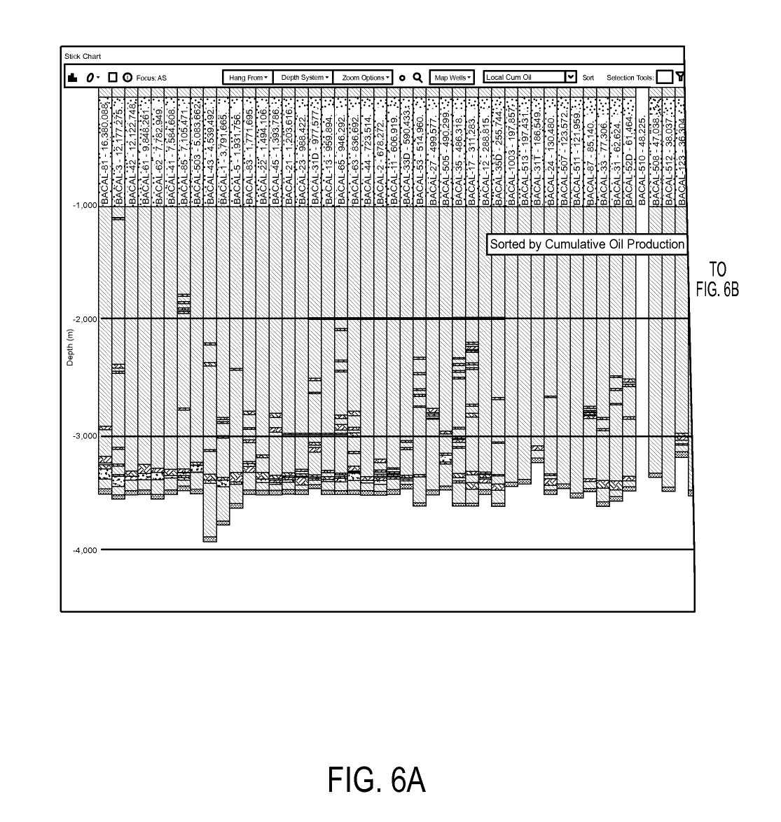

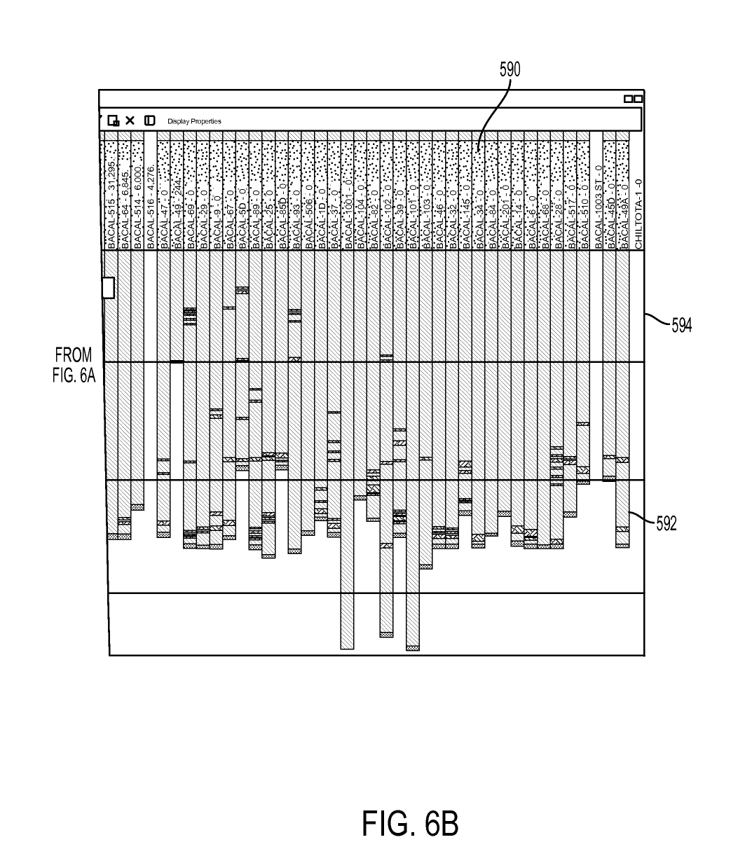

The system may also overlay wells with a transparent layer 590 showing selected properties for each well 592 in a stick chart 594 as shown in FIG. 6. Combining this feature with the sort feature above provides a powerful analytical tool. The combination can be used to do a multi-well select, quickly determining just the producing wells in the field.

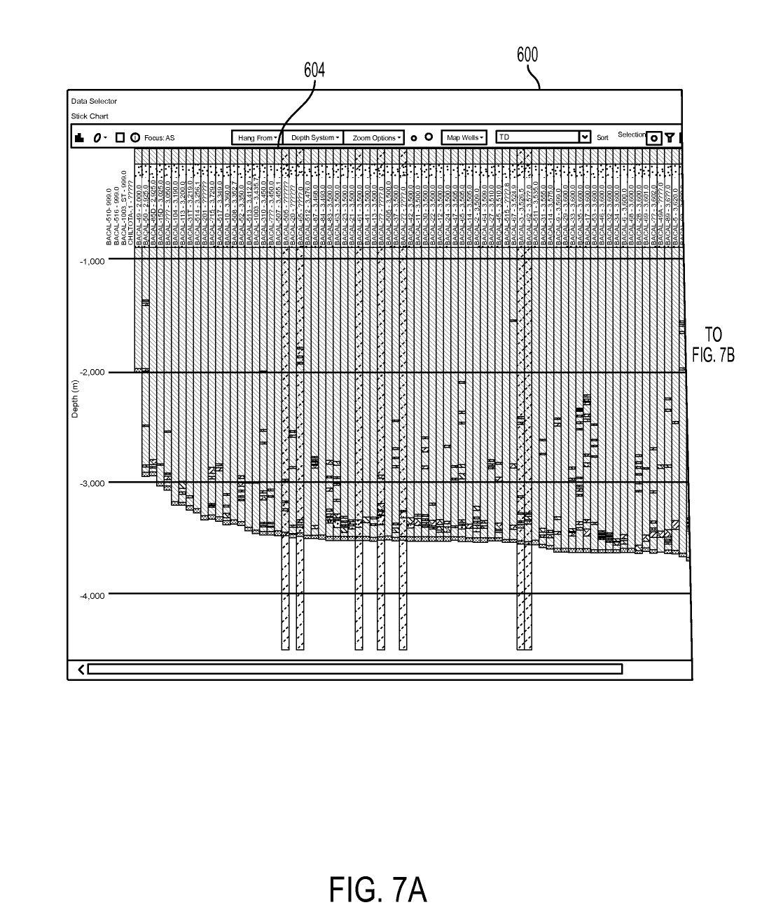

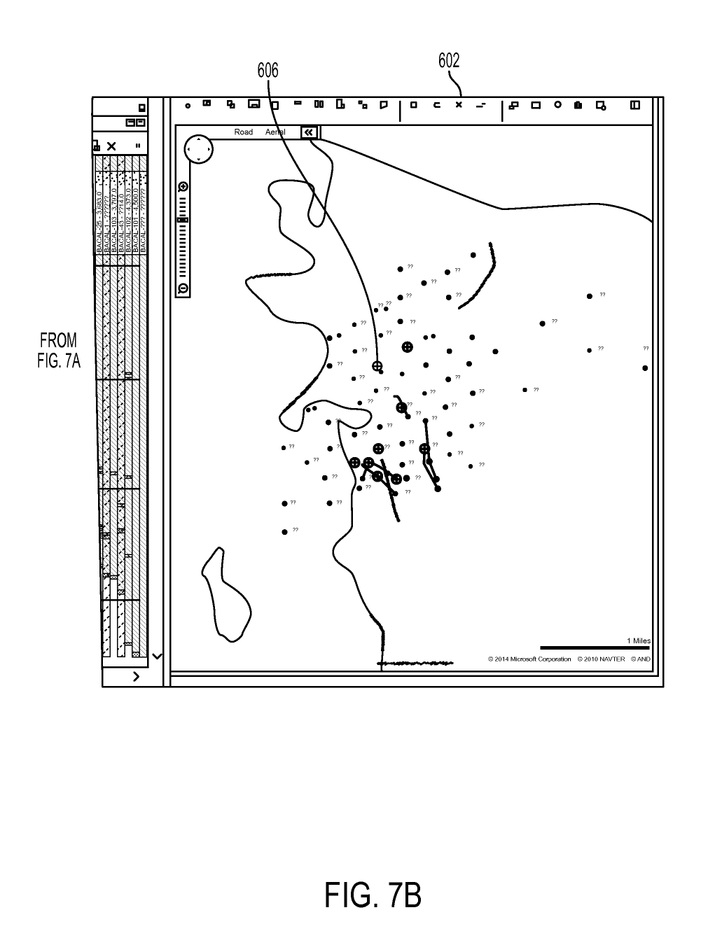

The user can create a map 300 shown in FIG. 3 that is tethered to the stick chart from the stick chart initiator (create map button 250) to create the combination display shown in FIG. 7 which includes a stick chart 600 and map 602. A web service request is then sent to the map control with the required well location information (X,Y) along with additional well details. The map 602 is created as a child window associated to the parent chart. The child map 602 and the parent stick chart 600 can share data stored in JSON objects. Filtering requests for data can be made between the map and the parent stick chart utilizing JavaScript functions. For example, the map control contains a polygon selector tool 310 for wells. Wells within the drawn polygon are filtered and the JavaScript request is sent to the parent Stickchart to redraw itself utilizing only the selected wells within the polygon.

As shown in FIG. 7 the stick chart 600 may be tethered with a map display 602 to facilitate visualization of key properties and wells. If a tethered map is desired, once wells 604 are selected on the stick chart 600 and then the well 606 are simultaneously selected on the map 602. Combining this feature with the well sorting feature can help tell the story of field development (what sequence were wells drilled in), best versus worst producers, well properties relative to geographic distribution, etc. All of the above data types displayed, viewing characteristics, sorting capabilities, overlay data options, can also be used with in tandem with the tethered map 602.

As an example, the system can display an entire field of wells and sort by first produced date and overlays specific information about each well such as total oil production. An operator can then toggle the system to display the tethered map 602. Utilizing the map selector and by moving from left to right within the map 602 the user can quickly determine the order in which the field was developed. Wells can then be selected individually or by group for further analysis.

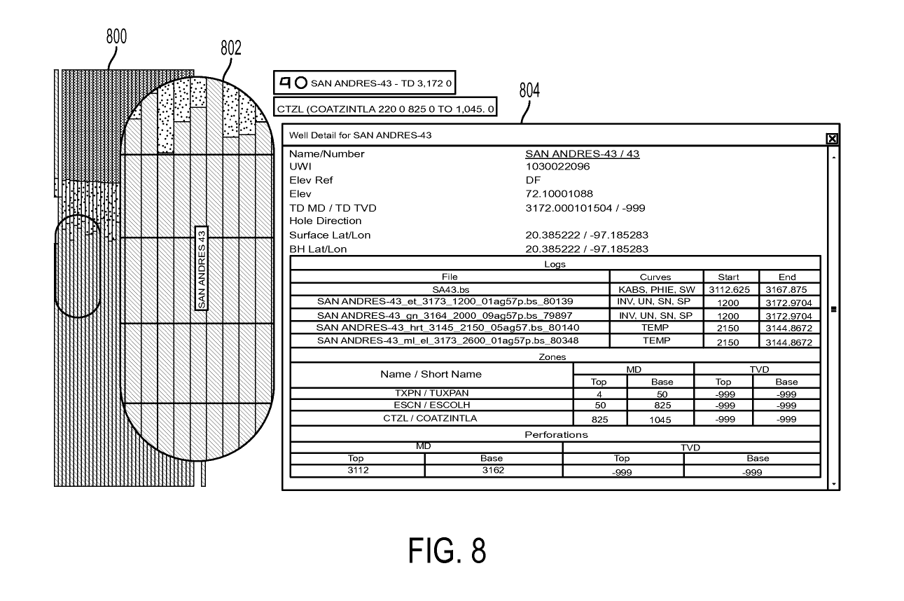

A stick chart 800 may also contain a Magnifier Focus Window 802 as shown in FIG. 8 when a user highlights the wells on the stick chart 800, the user can then click in the chart 800 where magnification is desired.

When a well is selected inside the Magnifier Focus Window, information for that well is displayed in a window 802 to the side of the Magnifier Focus Window 802. Double clicking a highlighted well opens its well page 804 in a separate window 802. Clicking on the well detail icon brings up the well detail page for the well.

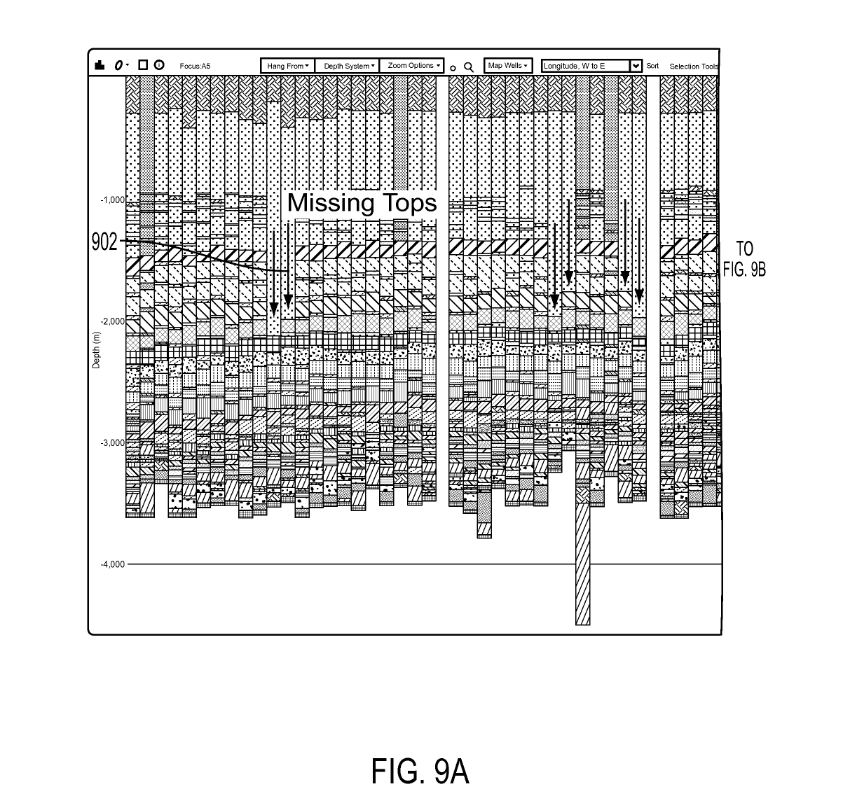

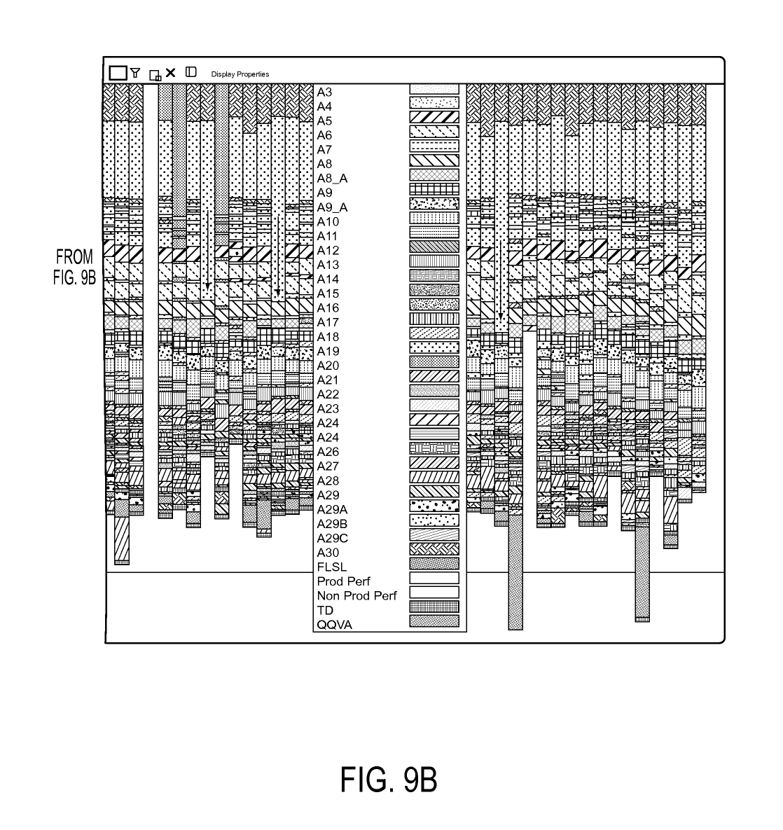

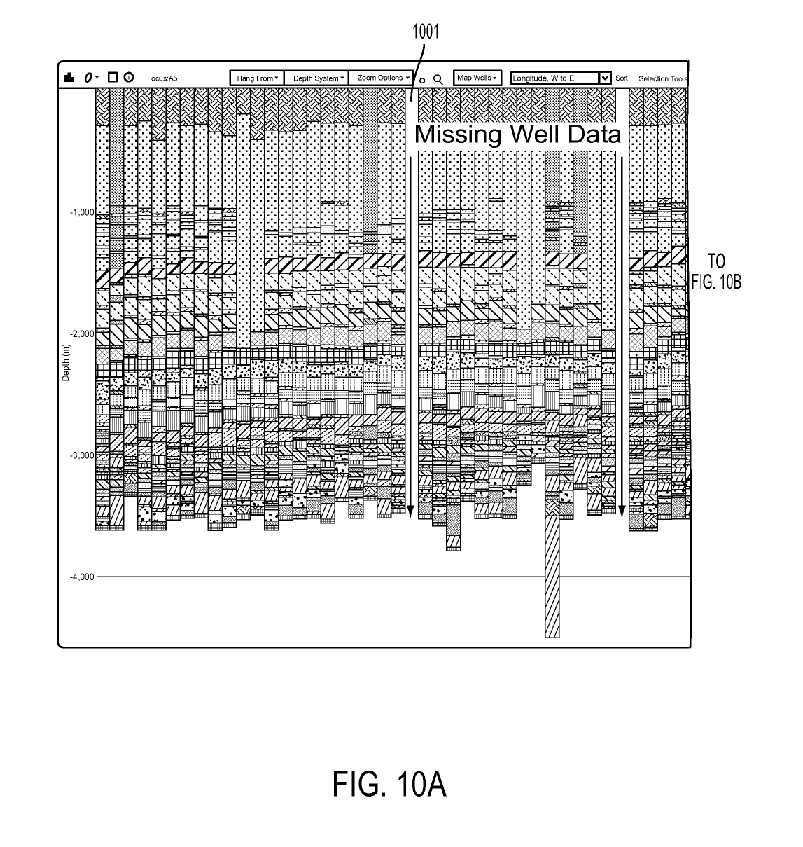

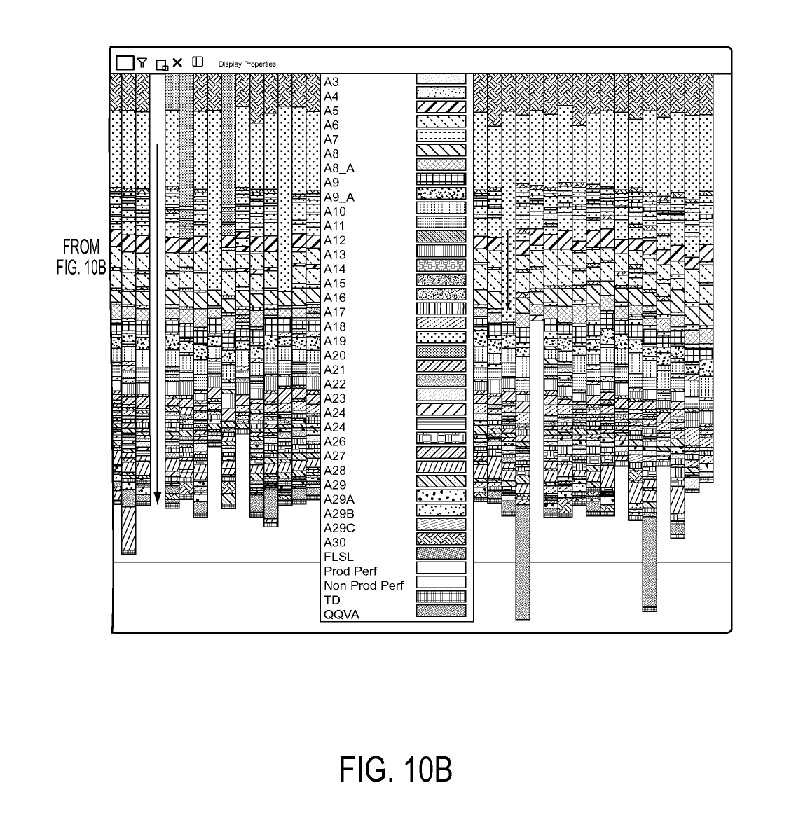

A stick chart generated by the system of the present invention can be used for many purposes. For example as shown in FIG. 9, the stick chart may show wells 902 with missing tops. FIG. 10 shows a stick chart in which wells 1001 with missing well data are easily identified.

While the foregoing invention has been described with reference to his preferred embodiments, various alterations and modifications will occur to those skilled in the art. All such alterations and modifications are intended the fall of the scope of the appended claims.

What is claimed is:

1. A system for quickly visualizing oil and gas field data comprising:
computer memory suitable for storing large databases;
a processor programmed to access data in said large databases and to present such data in a stick chart format and for connecting said stick chart of data to a tethered map, said processor fetching said data through asynchronous calls to said databases.

2. The system for quickly visualizing oil and gas field data of claim 1 wherein said processor exchanges data with said databases as structured data objects that allow encapsulation of arbitrarily complex data composed of numerous pieces of information.

3. The system for quickly visualizing oil and gas field data of claim 1 wherein said processor displays accessed data in a stick chart in which each rectangle in the stick chart represents a single well.

4. The system for quickly visualizing oil and gas field data of claim 1 wherein said processor is further programmed to generate a magnifier focus window over a stick chart and a corresponding window with well information for a well selected within said magnifier focus window.

5. A method for quickly visualizing oil and gas field data comprising the steps of:
accessing data from databases containing oil and gas well data, said data being accessed through asynchronous calls to said databases;
processing said access data and displaying said accessed data in a stick chart to which a tethered map of said data is attached.

6. The method for quickly visualizing oil and gas field data of claim 5 wherein data is sent to and from said databases as structured data objects that allow encapsulation of arbitrarily complex data composed of numerous pieces of information.

7. The method for quickly visualizing oil and gas field data of claim 5 wherein each rectangle in said stick chart represents a single well.

8. The method for quickly visualizing oil and gas field data of claim 5 further comprising the step of generating a magnifier focus window and corresponding information panel for a selected well within said magnifier focus window.
